(19) United States
(12) Patent Application Publication
(10) Pub. No.: US 2012/0128374 A1
(43) Pub. Date: May 24, 2012

(54) APPARATUS AND METHOD FOR PERFORMING COMMUNICATION USING POLARIZED LIGHT

(75) Inventors: Jung Ah YANG, Seoul (KR); Yeon Moon LEE, Goyang-si (KR); Keun Young LEE, Seoul (KR)

(73) Assignee: PANTECH CO., LTD., Seoul (KR)

(21) Appl. No.: 13/225,699

(22) Filed: Sep. 6, 2011

(30) Foreign Application Priority Data
Nov. 22, 2010 (KR) 10-2010-0116257

(51) Int. Cl. H04B 10/04; H04B 10/06

(52) U.S. Cl. 398/184; 398/202

(57) ABSTRACT

In an apparatus and a method for performing communication by using polarization property of light, a transmission apparatus includes a controller to establish a first channel corresponding to a first polarization property; a signal encoder to encode data into an electrical signal; a light emitting unit to emit light based on the electrical signal; and a polarizer to polarize the light into first polarized light having the first polarization property, and to output the first polarized light. A reception apparatus includes a controller to establish a first channel corresponding to a first polarization property; an analyzer to receive light, and to extract first polarized light having the first polarization property from the light; a polarized light receiver to convert the first polarized light to an electrical signal; and a signal decoder to decode the electrical signal to digital data.

### CROSS-REFERENCE TO RELATED APPLICATION

This application claims priority from and the benefit under 35 U.S.C. §119(a) of Korean Patent Application No. 10-2010-0116257, filed on Nov. 22, 2010, which is incorporated by reference for all purposes as if fully set forth herein.

### BACKGROUND

1. Field

The present disclosure relates to an apparatus and a method for performing communication using polarized light, and more particularly, to an apparatus and a method that may provide multiple communication channels using different polarizations of light in a visible light communication system.

2. Discussion of the Background

As luminous efficiency of a light emitting diode (LED) has improved and the price of the LED has fallen, the LED has become more common in market places for a special purpose lighting such as a portable device, an automobile, a traffic light, and a billboard, and in market places for a general purpose lighting such as a fluorescent lamp, and an incandescent lamp. Further, due to various reasons such as depletion of available radio frequency (RF) band resources, increased possibility of interference among many wireless communication technologies, an increasing demand for a communication security and the introduction of a broadband-ubiquitous communication environment of fourth generation (4G) wireless technology, an interest for an optical wireless technology as a complementary technology has increased.

The Visible Light Communication (VLC) refers to a communication technology that transmits information using visible light. In the VLC technology, data may be transmitted by controlling an emission of visible light emitted from a device having a light emitting device such as an LED, and the like. The VLC may not need an allocated frequency, and may enable a rapid transmission of a large amount of data using a rapid flicker.

In the VLC technology, since propagation direction of light is visible, a reception range of information may be more accurately estimated than that of other wireless communication technologies. The VLC technology may be more reliable in the aspects of security and low-power consumption. Accordingly, the VLC technology may be applicable to a hospital and an airplane where the RF communication is partially or wholly restricted.

The VLC technology may be appropriate for one-on-one communication based on a single physical channel. However, in a communication environment where there are many receivers, or where multiple channels are used, a single-channel based VLC technology may be deficient.

### SUMMARY

Exemplary embodiments of the present invention provide a transmission apparatus, reception apparatus and method for performing communication using a polarized light in a visible light communication system.

Additional features of the invention will be set forth in the description which follows, and in part will be apparent from the description, or may be learned by practice of the invention.

An exemplary embodiment of the present invention provides a transmission apparatus including a controller to establish a first channel corresponding to a first polarization property; a signal encoder to encode data into an electrical signal; a light emitting unit to emit light based on the electrical signal; and a polarizer to polarize the light into first polarized light having the first polarization property, and to output the first polarized light.

An exemplary embodiment of the present invention provides a reception apparatus including a controller to establish a first channel corresponding to a first polarization property; an analyzer to receive light, and to extract first polarized light having the first polarization property from the light; a polarized light receiver to convert the first polarized light to an electrical signal; and a signal decoder to decode the electrical signal to digital data.

An exemplary embodiment of the present invention provides a method for transmitting data using a polarized light including establishing a first channel corresponding to a first polarization property of light; setting a polarizer to convert light into polarized light having the first polarization property; encoding data into an electrical signal; emitting light based on the electrical signal; and converting the light into polarized light having the first polarization property and outputting the polarized light.

An exemplary embodiment of the present invention provides a method for receiving data using polarized light including establishing a first channel corresponding to a first polarization property of light; setting an analyzer to identify first polarized light having the first polarization property; obtaining first polarized light having the first polarization property using the analyzer; converting the first polarized light to an electrical signal; and converting the electrical signal to digital data.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a visible light communication system to perform communication using polarized light according to an exemplary embodiment of the present invention.

FIG. 2 is flowchart illustrating a method for performing communication using polarized light according to an exemplary embodiment of the present invention.

FIG. 3 is flowchart illustrating a method for performing communication using polarized light according to an exemplary embodiment of the present invention.

FIG. 4 is a diagram illustrating types of waveforms of light based on different polarization states according to an exemplary embodiment of the present invention.

FIG. 5 is a diagram illustrating generation of linearly polarized light according to an exemplary embodiment of the present invention.

FIG. 6 is a diagram illustrating a circular polarizer to convert light into circularly polarized light according to an exemplary embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth herein. Rather, these exemplary embodiments are provided so that the present disclosure is thorough, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X).

Exemplary embodiments of the present invention provide a visible light communication system and method for generating a communication channel using visible light having different polarization property. The visible light communication system may include a transmission apparatus and a reception apparatus.

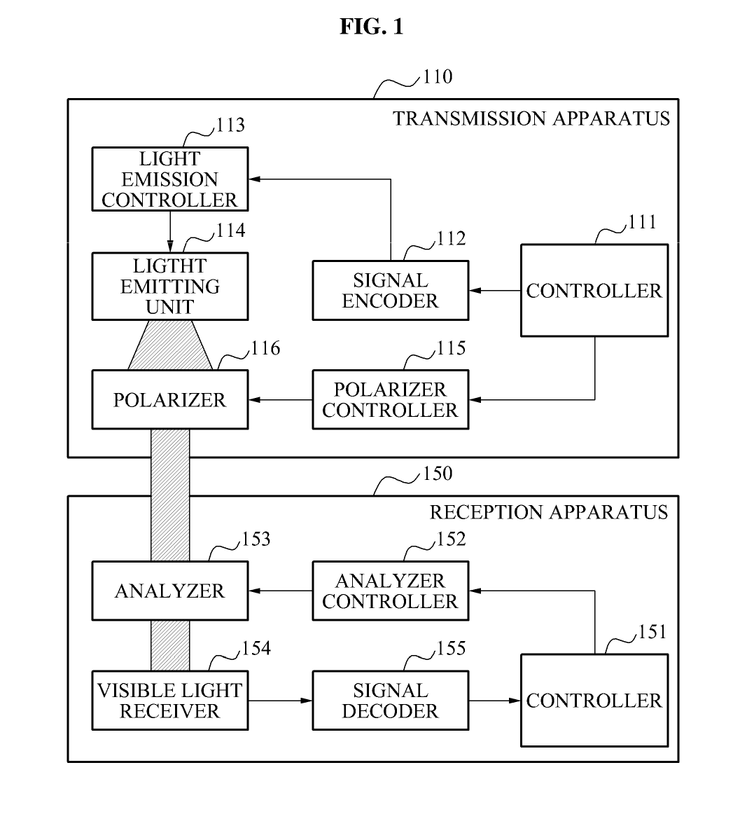

FIG. 1 is a diagram illustrating a visible light communication system to perform communication using polarized light according to an exemplary embodiment of the present invention.

As shown in FIG. 1, the visible light communication system may include a transmission apparatus 110 and a reception apparatus 150.

The transmission apparatus 110 may include a controller 111, a signal encoder 112, a light emission controller 113, a light emitting unit 114, a polarizer controller 115, and a polarizer 116.

The signal encoder 112 may encode data to an electrical signal. For example, ‘Manchester coding’ may be used to encode the data. The signal encoder 112 may further modulate the electrical signal to a format to be transmitted using visible light communication through the light emitting unit 114. For example, ‘On-off keying (OOK)’ modulation method may be used to modulate the electrical signal.

The light emission controller 113 may control the light emitting function of the light emitting unit 114 in order to transmit visible light according to the electrical signal transmitted from the signal encoder 112.

The light emitting unit 114 may emit visible light under the control of the light emission controller 113. In an example, the light emitting unit 114 may include a light emitting diode (LED). The light emitting unit 114 may include a single LED or an array of multiple LEDs. If the light emitting unit 114 includes an array of multiple LEDs, different polarization property may be applied to each of the LEDs, respectively.

The polarizer controller 115 may control the polarizer 116. The polarizer controller 115 may control the polarizer 116 according to the control of the controller 111. The polarizer controller 115 may control the polarizer 116 based on input visible light information and output visible light information. The input visible light information may include the polarization state of the visible light emitted from the light emitting unit 114, and the output visible light information may include the polarization state of the visible light to be converted by the polarizer 116. The input visible light information and the output visible light information may be determined by the controller 111 and be transmitted to the polarizer controller 115.

The polarizer 116 may convert depolarized visible light emitted from the light emitting unit 114 to polarized visible light, and output the polarized visible light. The polarizer 116 may convert a plane wave emitted from the light emitting unit 114 to polarized visible light. The polarizer 116 is controlled by the polarizer controller 115 and may use the input visible light information and the output visible light information for operation. The polarization property may be used to distinguish a physical channel different from the depolarized visible light. The polarizer 116 may include a linear polarizer, a circular polarizer, an elliptical polarizer, and any combination thereof.

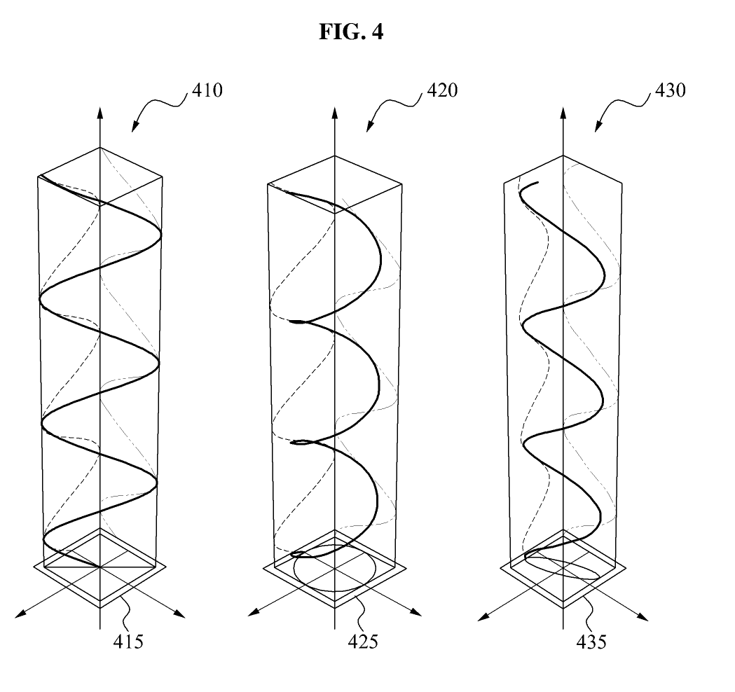

FIG. 4 is a diagram illustrating types of waveforms of light based on different polarization states according to an exemplary embodiment of the present invention.

Referring to FIG. 4, a polarization property may be classified as a linear polarization 410, a circular polarization 420, and an elliptical polarization 430.

Light as an electromagnetic wave may maintain the electric field and magnetic field being perpendicular to the direction of propagation and to each other. Light waves may be indicated by magnetic and electric field vectors on a plane which is perpendicular to the direction of propagation. Since magnetic field is perpendicular to the electric field and proportional to it, magnetic field vectors are not expressly shown in FIG. 4. As shown in FIG. 4, examples of the electric field vectors (solid line), with time (the vertical axes), at a particular point in space, along with the electric field vector's x and y components (dotted line and dash with two dots) are depicted. The x and y components are orthogonal. The paths traced by the tip of the electric field vectors in the planes 415, 425, and 435 are linear, circular, and elliptical, respectively. If phase difference between the x and y components of the electric field vector is 0, the tip of the electric field vector traces out a straight line in the plane 415. This light wave is referred to as the linear polarization 410. If phase difference exists between the x and y components of the electric field vector, the tip of the electric field vector may not trace out a single line in the plane. If amplitudes of the x and y components of the electric field vector are the same, and the phase difference is 90°, the tip of electric field vector traces out a circle in the plane 425. This light wave is referred to as the circular polarization 420. If the tip of the field vector traces out an ellipse in the plane 435, this light wave is referred to as the elliptical polarization 430. The linear polarization and the circular polarization are special cases of an elliptical polarization.

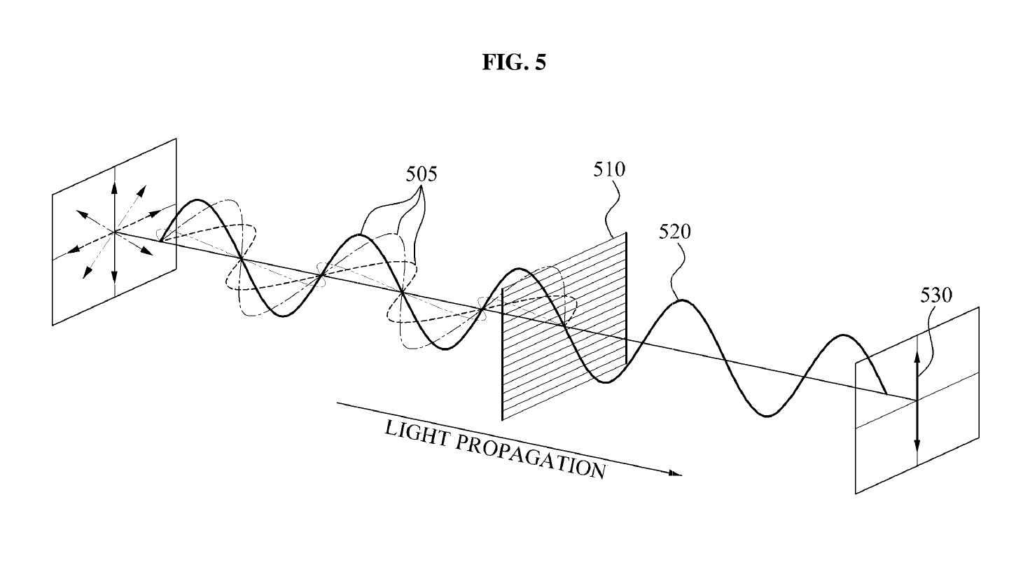

FIG. 5 is a diagram illustrating generation of linearly polarized light according to an exemplary embodiment of the present invention.

A polarizer is an apparatus that converts electromagnetic waves of undefined or mixed polarization into a wave with better-defined polarization. Referring to FIG. 5, a linear polarizer refers to an apparatus which converts depolarized light or light having mixed polarization states to light having a linear polarization property. In an example, the linear polarizer may be a wire-grid polarizer which may convert depolarized light or polarized light to linearly polarized light.

A wire-grid polarizer 510 may include an array of fine parallel metallic wires. The wire-grid polarizer 510 may pass only electromagnetic waves having polarization direction (or “electric field vector”) 530 perpendicular to the aligned direction of the metallic wires, and may absorb or reflect remaining light, thereby converting electromagnetic waves of mixed polarization 505 into a wave 520 having the polarization direction 530 perpendicular to the aligned direction of the metallic wires. The polarization direction 530 of the wave 520 that penetrates the wire-grid polarizer 510 is also referred to as a polarization axis 530.

In an example, light E1 which penetrated the wire-grid polarizer 510 such that the angle between the polarization axis of the wire-grid polarizer 510 and the moving direction is θ1 and light E2 which penetrated the wire-grid polarizer 510 such that the angle between the polarization axis of the wire-grid polarizer 510 and the moving direction is θ2 may have different polarization properties. That is, the two lights E1 and E2 have distinguishing characteristics. Accordingly, each of the lights E1 and E2 may be considered as different channels and a polarizer may transmit the light by changing polarization axis according to a channel through which data is to be transmitted. In this way, the polarizer may create multiple transmission channels according to the distinguishing polarizations of light from the wire-grid polarizer 510.

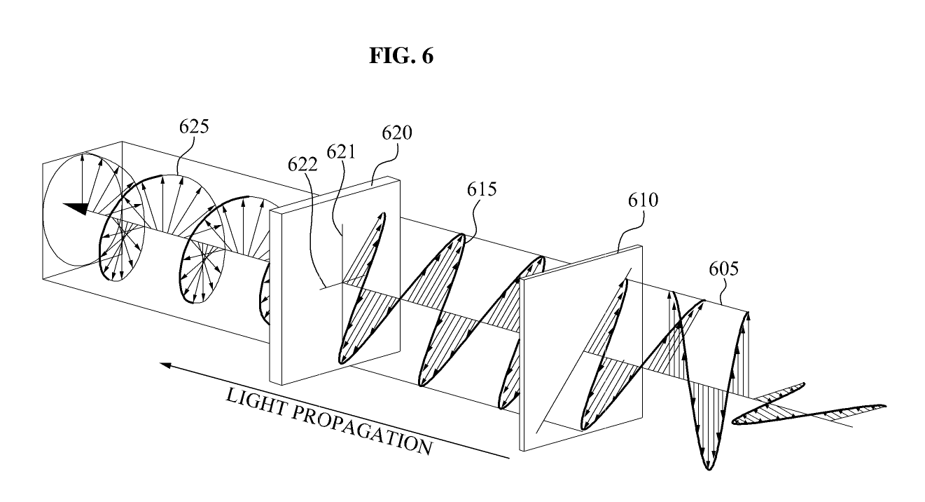

FIG. 6 is a diagram illustrating a circular polarizer to convert light into circularly polarized light according to an exemplary embodiment of the present invention.

Referring to FIG. 6, the circular polarizer refers to an apparatus that may generate a circularly polarized light, and is also referred to a polarizing filter.

The circular polarizer may convert depolarized light or light having undefined or mixed polarization to circularly polarized light. The polarizing process may be fulfilled by polarizing the depolarized light into linearly polarized light through the linear polarizer and by passing the linearly polarized light through a wave plate. The wave plate may be a quarter-wave plate.

If the linearly polarized light which passed through the linear polarizer 610 penetrates the wave plate 620, phase difference between vertical component and horizontal component of the electric field may occur, and the linearly polarized light may be converted to circularly polarized light or elliptically polarized light. If the wave plate is quarter plate, the phase difference is 90° and the linearly polarized light is converted into a circularly polarized light. Further, circularly polarized light may be left-handed circularly polarized light or right-handed circularly polarized light. In addition, vertical axis 621 may be fast axis and horizontal axis 622 may be slow axis or vice versa. The wave component of the linearly polarized light, which passes through the slow axis travels at a slower speed than the wave component of the linearly polarized light, which passes through the fast axis. This speed difference generates the phase difference between two orthogonal components of the linearly polarized light. If the horizontal axis 622 is referred to as the light axis, the speed of the vertical component of light that travels through the vertical axis may be faster than the speed of the horizontal component of light that travels through the light axis while passing through the wave plate 620. Accordingly, a phase difference may occur between the vertical and horizontal components of linearly polarized light, and the linearly polarized light may be transformed into a circularly polarized light by the phase difference.

The phase shift occurs due to the speed difference between the vertical and horizontal components of the linearly polarized light. The degree of phase shift may be controlled by the thickness of the wave plate 620. A wave plate causing phase difference of π/2, that is, quarter-wavelength phase shift, by adjusting the thickness of the wave plate is referred to as a quarter wave plate. Linearly polarized light having an angle of incidence of 45° to the quarter wave plate may be converted into circularly polarized light. If the phase difference is π, half a wavelength, one polarized component of the electric field may become negative (−). That is, one polarized component of the electric field changes its sign but maintains the same magnitude. This wave plate is referred to as a half wave plate which may include two stacked quarter wave plates. As described above, a polarization property may be changed by changing the thickness of the wave plate.

The controller 111 may control overall operation of the transmission apparatus 110. The controller 111 may execute a portion of or all the functions of the signal encoder 112, the light emission controller 113, and the polarizer controller 115. The controller 111, the signal encoder 112, the light emission controller 113, and the polarizer controller 115 are separately illustrated in order to describe each of the functions separately. Thus, the controller 111 may include one or more processors to execute one or more of the functions of the signal encoder 112, the light emission controller 113, and the polarizer controller 115. The controller 111 may execute a portion of the functions of the signal encoder 112, the light emission controller 113, and the polarizer controller 115.

The controller 111 may establish a channel distinguished by a certain polarization property for communication with the reception apparatus 150, and may control to transmit data using polarized visible light corresponding to the established channel. The established channel may include an uplink channel and a downlink channel, and the uplink channel and the downlink channel may have different polarization properties.

The controller 111 may establish a broadcasting channel using visible light having a certain polarization property. The broadcasting channel is a channel through which many reception apparatuses may commonly receive data from a transmission apparatus. For example, unicasting channels may be established by linearly polarized visible lights having various polarization directions, and the broadcasting channel may be established by circularly polarized visible lights. Alternatively, the unicasting channels may be established by elliptically polarized visible lights, and the broadcasting channel may be established by circularly polarized visible lights.

The controller 111 may control to transmit broadcasting signal including channel information. The channel information may include broadcasting channel information and unicasting channel information. The broadcasting channel information may include broadcasting channel setting information, synchronization information, transmission time slot information for a reception apparatus, and polarization property information for the broadcasting channel. The unicasting channel information may include unicasting channel setting information, synchronization information, and polarization property information for the unicasting channel. For example, the transmission time slot information for a reception apparatus may include timeslot for a reception apparatus to transmit data to the transmission apparatus, timeslot for the reception apparatus to broadcast, and the like. The polarization property information may include polarization type information such as linear, circular, and elliptical. The polarization property information may also include polarization direction information such as polarization direction of linearly polarized light, left-handed/right-handedness of circularly polarized light, directions of major or minor axes of elliptically polarized light, and eccentricity or phase difference of elliptically polarized light. The channel information may be used for a channel establishment. The controller 111 may broadcast channel information at an interval to synchronize the polarizer 116 and the analyzer 153, and to receive request channel information from the reception apparatus 150. The request channel information may include information of the channel requested by the reception apparatus 150. The request channel information may be received by the transmission apparatus 110 using an uplink channel of the channel requested to be used, an uplink channel having a determined polarization property, or other communication media. The other communication media may include a near field communication such as an infrared communication, Bluetooth communication, Wi-Fi communication, and the like.

The reception apparatus 150 may include a controller 151, an analyzer controller 152, an analyzer 153, a visible light receiver 154, and a signal decoder 155.

The analyzer controller 152 may control the analyzer 153 to analyze received polarized visible light and to extract polarized visible light corresponding to an established channel. The established channel may be established by the controller 151.

The analyzer 153 may analyze received visible light. The analyzer 153 may extract polarized visible light corresponding to the established channel and transmit the polarized visible light to the visible light receiver 154 based on the control of analyzer controller 152.

The visible light receiver 154 may receive the polarized visible light from the analyzer 153, and convert the polarized visible light into an electrical signal. The visible light receiver 154 may include a photo diode or an image sensor.

The signal decoder 155 may convert the electrical signal to digital data, and perform decoding to obtain data transmitted by the visible light. The signal decoder 155 may amplify the electrical signal, and demodulate the electrical signal before the decoding.

The controller 151 may control a portion of or all the operation of the reception apparatus 150. The controller 151 may execute portions of or the entire functions of the analyzer controller 152 and the signal decoder 155. The controller 151, the analyzer controller 152, and the signal decoder 155 are separately illustrated in order to describe each of the functions separately. Thus, the controller 151 may include one or more processors to execute one or more of the functions of the analyzer controller 152 and the signal decoder 155. The controller 151 may execute a portion of the functions of the analyzer controller 152 and the signal decoder 155.

The controller 151 may establish a channel distinguished by a polarization property for communication with the transmission apparatus 110, and may control to receive data using polarized visible light corresponding to the established channel. The established channel may include an uplink channel and a downlink channel, and the uplink channel and the downlink channel may have different polarization properties.

The controller 151 may establish a channel distinguished by a certain polarization property for communication with the transmission apparatus 110 using a broadcasting channel having a determined polarization property.

The controller 151 may establish a channel using visible light having a certain polarization property. The channel may be established by receiving the channel information transmitted from the transmission apparatus 110 through broadcasting channel, and by transmitting request channel information requested to be used by the reception apparatus 150 to the transmission apparatus 110. The channel information may be broadcasted at a time interval, and may be used to synchronize the polarizer 116 and the analyzer 153. The request channel information may be transmitted using an uplink channel of the channel desired to be used, an uplink channel having a determined polarization property, or other communication media. The other communication media may include a near field communication such as an infrared communication, Bluetooth communication, Wi-Fi communication, and the like.

Hereinafter, a method for performing communication using a polarized light will be described with reference to the accompanying drawings.

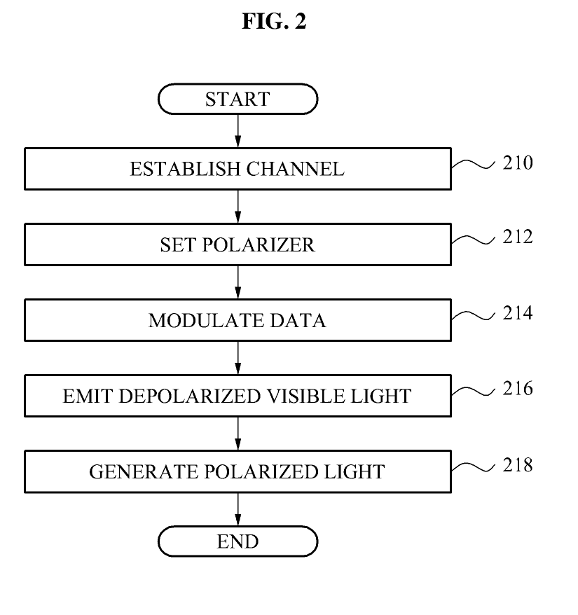

FIG. 2 is a flowchart illustrating a method for performing communication using polarized light according to an exemplary embodiment of the present invention.

Referring to FIG. 2, a transmission apparatus may establish a channel using visible light having a polarization property for communication with a reception apparatus in operation 210. In operation 210, the transmission apparatus may establish a channel by broadcasting channel information used for a channel establishment through a broadcasting channel, and by receiving, from the reception apparatus, request channel information having channel information of a channel requested to be used. The request channel information may be received using an uplink channel of the channel requested to be used, an uplink channel having a determined polarization property, or other communication media. The other communication media may include a near field communication such as an infrared communication, Bluetooth communication, Wi-Fi communication, and the like.

In operation 212, the transmission apparatus may set a polarizer to convert visible light to polarized visible light corresponding to a determined channel based on the channel information and request channel information. In operation 214, the transmission apparatus may encode data and modulate the encoded data to an electrical signal.

In operation 216, the transmission apparatus may emit depolarized visible light based on the modulated electrical signal. In operation 218, the transmission apparatus may generate polarized light by converting the depolarized visible light to polarized visible light using the polarizer.

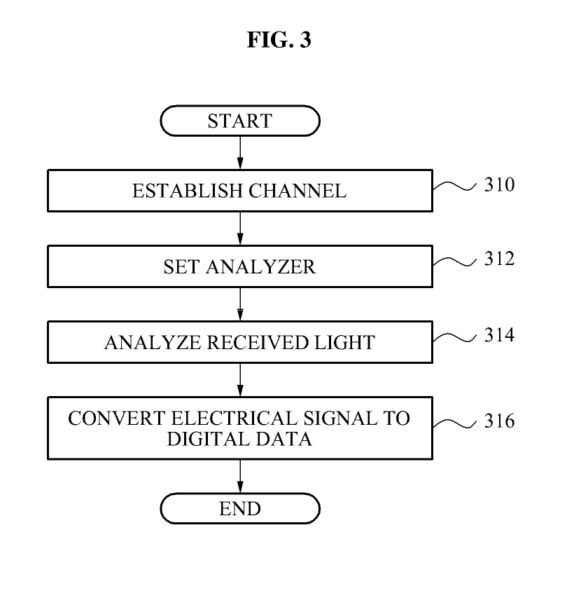

FIG. 3 is a flowchart illustrating a method for performing communication using polarized light according to an exemplary embodiment of the present invention.

Referring to FIG. 3, a reception apparatus may establish a channel using visible light having a polarization property for communication with a transmission apparatus in operation 310. In operation 310, the reception apparatus may establish a channel by receiving channel information used for a channel establishment through a broadcasting channel, and by transmitting request channel information having channel information of a channel desired to be used to the transmission apparatus. The request channel information may be transmitted using an uplink channel of the channel requested to be used, an uplink channel having a determined polarization property, or other communication media. The other communication media may include a near field communication such as an infrared communication, Bluetooth communication, Wi-Fi communication, and the like.

In operation 312, the reception apparatus may set an analyzer to analyze received light for the established channel based on the channel information of the corresponding channel.

In operation 314, the reception apparatus may analyze the received light. The reception apparatus 150 may extract the polarized visible light corresponding to the established channel from the received visible light.

In operation 316, the reception apparatus may convert the polarized visible light to an electrical signal, and convert the electrical signal to digital data.

The exemplary embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts.

The transmission apparatus may change setting of the polarizer included in the transmission apparatus to allocate communication channels having different polarization properties. Thus, the transmission apparatus may perform multicast communication with multiple reception apparatuses by establishing multiple communication channels distinguished by different polarization properties of light. The multicast communication may be performed by using time sharing scheme or by allocating different physical channel for each light emitting diode if a plurality of LEDs are used.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A transmission apparatus, comprising:
a controller to establish a first channel corresponding to a first polarization property;
a signal encoder to encode data into an electrical signal;
a light emitting unit to emit light based on the electrical signal; and
a polarizer to polarize the light into first polarized light having the first polarization property, and to output the first polarized light.

2. The transmission apparatus of claim 1, wherein the controller further establishes a second channel corresponding to a second polarization property, and
the polarizer further polarizes the light into second polarized light having the second polarization property, and to output the second polarized light.

3. The transmission apparatus of claim 1, wherein the first polarization property comprises at least one of a linear polarization, a circular polarization, and an elliptical polarization.

4. The transmission apparatus of claim 2, wherein the controller establishes a broadcasting channel as the first channel, controls to broadcast channel information using the broadcasting channel, and establishes the second channel based on request channel information received from a reception apparatus through the broadcasting channel.

5. The transmission apparatus of claim 4, wherein
the second polarization property comprises at least one of a linear polarization, a circular polarization, and an elliptical polarization, and
the first polarization property has a polarization property different from the second polarization property.

6. The transmission apparatus of claim 2, wherein the second channel comprises an uplink channel and a downlink channel, and the uplink channel and the downlink channel have different polarization properties.

7. The transmission apparatus of claim 1, wherein the polarizer comprises a linear polarizer and a wave plate to change a polarization property of the light.

8. The transmission apparatus of claim 1, wherein the polarizer controls two orthogonal components of electric field of the light to change a polarization property of the light.

9. The transmission apparatus of claim 1, wherein the light emitting unit comprises a first light emitting diode and a second light emitting diode, and the first light emitting diode emits polarized light having a different polarization property from polarized light emitted by the second light emitting diode.

10. A reception apparatus, comprising:
a controller to establish a first channel corresponding to a first polarization property;
an analyzer to receive light, and to extract first polarized light having the first polarization property from the light;
a polarized light receiver to convert the first polarized light to an electrical signal; and
a signal decoder to decode the electrical signal to digital data.

11. The reception apparatus of claim 10, wherein the controller further establishes a second channel corresponding to a second polarization property,
the analyzer further extracts second polarized light having the second polarization property, and
the polarized light receiver further converts the second polarized light to an electrical signal.

12. The reception apparatus of claim 10, wherein the first polarization property comprises at least one of a linear polarization, a circular polarization, and an elliptical polarization.

13. The reception apparatus of claim 11, wherein the controller establishes a broadcasting channel as the first channel, controls a reception of channel information using the broadcasting channel, controls a transmission of request channel information comprising information of the second channel, and establishes the second channel.

14. The reception apparatus of claim 13, wherein:
the second polarization property comprises at least one of a linear polarization, a circular polarization, and an elliptical polarization, and
the first polarization property has a polarization property different from the second polarization property.

15. The reception apparatus of claim 11, wherein the second channel comprises an uplink channel and a downlink channel, and the uplink channel and the downlink channel have different polarization properties.

16. The reception apparatus of claim 10, wherein the analyzer comprises a linear polarizer and a wave plate to change a polarization property of the light.

17. A method for transmitting data using a polarized light, comprising:
establishing a first channel corresponding to a first polarization property of light;
setting a polarizer to convert light into polarized light having the first polarization property;
encoding data into an electrical signal;
emitting light based on the electrical signal; and
converting the light into polarized light having the first polarization property and outputting the polarized light.

18. The method of claim 17, wherein the establishing the first channel comprises:
establishing a broadcasting channel corresponding to a second polarization property of light;
broadcasting channel information through the broadcasting channel;
receiving request channel information comprising information of the first channel; and
establishing the first channel corresponding to the first polarization property of light.

19. A method for receiving data using polarized light, comprising:
establishing a first channel corresponding to a first polarization property of light;
setting an analyzer to identify first polarized light having the first polarization property;
obtaining first polarized light having the first polarization property using the analyzer;
converting the first polarized light to an electrical signal; and
converting the electrical signal to digital data.

20. The reception method of claim 19, wherein establishing the first channel comprises:
receiving channel information through a broadcasting channel;
transmitting request channel information comprising information of the first channel; and
establishing the first channel corresponding to the first polarization property of light.
